(19) United States
(12) Patent Application Publication
(10) Pub. No.: US 2017/0186260 A1
(43) Pub. Date: Jun. 29, 2017

(54) ANONYMOUS AND SECURE ELECTRONIC VOTING SYSTEM FOR USE IN OPEN NETWORKS

(71) Applicant: Juan José Bermúdez, Hospitalet de Llobregat (ES)

(72) Inventor: Juan José Bermúdez, Hospitalet de Llobregat (ES)

(21) Appl. No.: 15/300,308

(22) PCT Filed: Jun. 2, 2015
(86) PCT No.: PCT/ES2015/070430

§ 371 Date: Sep. 29, 2016

(30) Foreign Application Priority Data
Jun. 17, 2014 (ES) P201430923

(51) Int. Cl. G07C 13/00; H04L 29/06

(52) U.S. Cl. CPC G07C 13/00; H04L 63/1408; H04L 63/145; H04L 63/0853; H04L 63/0823; H04L 63/123

(57) ABSTRACT

The objective of the present invention is a distributed electronic voting system of the type permitting the performance of an election regarding a given issue and using remote terminals interconnected by means of an open telecommunication network (such as Internet). The method is characterized by comprising (a) a phase in which virtual ballots are created, (b) a phase in which an order between the Voting Agents is established, (c) a phase in which each Voting Agent successively extracts a virtual ballot, (d) a phase in which the last agent makes the list of remaining ballots public, (e) a phase in which each agent verifies the coherence of the data and communicates any possible mistake in that, (f) a phase in which each agent asks for additional information to other agents so that they can make additional security verifications.

### BACKGROUND

This far, the current state-of-the-art with regard to electronic voting systems through an unsafe communication network (as, tentatively, Internet) has been unable to eliminate the need for one or several authorities to supervise the electoral process, or for the participants in the election to be obliged to place their confidence in such authorities (or in personnel involved in the same) and trust that they will not be ignoring the rules for their own benefit. Other problems have been solved, such as preventing votes to be manipulated or that any individual gets to know the election by a voter; however, as a general rule, this was attained by means of very expensive infrastructures that, do generally need to be managed by trusted staff and audited by independent entities. In practice, often, this results in the fact that elections organized by public agencies do not allow votes by Internet or even preferring the traditional voting slips to any other electronic system.

The problem involved in guaranteeing the secrecy of the election has been solved, as far as the trusted authority/ties collecting the results of the election or participating in any of the steps of the electronic voting system is/are excluded. Furthermore, some inventions have theoretically guaranteed such secrecy with regard to such authorities if it is assumed that they shall not co-operate with each other in order to find out about a citizen's vote and that uncontrolled staff within the structures of those authorities will not have any possibility to co-operate for such purpose (WO 2003050771 A1, [Fujioka, A., Okamoto, T. y Ohta, K. A practical secret voting scheme for large scale elections. Proc. of Auscrypt '92, LNCS 718, pp. 244-251, 1992], [Park, C, Itoh, K. y Kurosawa, K. Efficient anonymous channel and all/nothing election scheme. Proc. of Eurocrypt '93, LNCS 765, pp. 248-259, 1993], U.S. Pat. No. 6,317,833). Some of such inventions (e.g., WO 2003050771 A1) do also require the availability of several computer programs whose correct operation and impossibility of uncontrolled access are guaranteed. Any security failure in the access to such programs could be catastrophic.

### Definitions:

P2P network: A computer network in which every computer acts as both a client and server, allowing every computer to exchange data and services with every other computer in the network.

### BRIEF DESCRIPTION OF THE INVENTION

The objective of the present invention is a distributed, anonymous and safe electronic voting system.

The system is composed by a terminal, a term that, in the present invention, is understood as any device liable to show, through visualization means, the contents of a website or digital contents, thus including computers, mobile phones, tablets, portable computers, intelligent watches, intelligent glasses, digital television sets, etc. In case the voter wasn't a person, but an electronic circuit or a computer, the terminal can be omitted.

A Voting Agent (downloadable or pre-installed in the terminal) containing the necessary operating tools for the votes of the users to be processed and registered by the system. Such module includes operating tools for communication with other terminals, encryption and data certification operations and operating tools for the detection of errors or of malicious attacks against the election process. In case the voter is an electronic circuit or a computer, such a Voting Agent may be integrated in the same circuit, made a part of the software installed on the computer, or made a part of an independent device connected to the computer or an electronic device.

Optionally, there may be (a) one (or more) central Count Server that collects the data provided by the terminals, or (b) a set of nodes, interconnected by a P2P network, which collect and store the data in a distributed and cooperative manner.

Optionally, there may be one (or more) Servers for Voter Authentication (which may coincide with any other server in this invention).

Optionally, there may be one (or more) Servers for Certification (which may coincide with any other server in this invention).

Optionally, there may be one (or more) Server(s) for the Control of Clusters (which may coincide with any other server in this invention).

Optionally, there may be one (or more) Servers for the Publication of results (which may coincide with any other server in this invention).

The features of this invention do not force the voters to trust the goodwill of one or several authorities or of any of its (their) members. Some of the options for the application of the present invention imply the participation of trusted authorities that, theoretically, may exercise an undue behavior, although with less critical consequences than in previous inventions. Even when servers from trusted authorities are used, the data is always replicated and certified against modifications and the authorities are unable to know for certain the individual vote of a given voter. Any undue behavior aimed at modifying the goal of the vote or its secrecy, can be detected by the voters themselves. In case of non-authorized access to the servers by a trusted authority, any alteration of the data can be detected and corrected by collecting the data once more. In some of the options for application of this invention, the presence of trusted authorities is not even required for participation in the voting verification process.

### BRIEF DESCRIPTION OF THE DRAWINGS

FIG. 1a shows a block diagram with a partial illustration of the data flow that takes place in the connection phase of the present invention among the parties involved in the system, when one of the parties participating is a P2P network that stores the outcomes in a collaborative way. This corresponds with phase 1 in the detailed description of the invention:
Voter 1, by means of Agent 1 (arrow 1), makes a connection petition (arrow 2) to the P2P network, which responds (arrow 3) by sending the data needed to connect to a cluster.
Agent 1 then makes a connection petition to the cluster (arrow 4) and gets the list of voters who have already joined the cluster.
Agent 1 then verifies the identity of the members of the cluster by means of an Authentication Server (arrow 5).

FIG. 1b shows a block diagram with a partial illustration of the data flow that takes place in the connection phase of the present invention among the parties involved in the system, when there is a central authority providing the connection data to the voting clusters. Such authority provides a Cluster Control Server. This corresponds with phase 1 in the detailed description of the invention:
Voter 1, by means of Agent 1 (arrow 1), makes a connection petition (arrow 2) to the Cluster Control Server, which responds (arrow 3) by sending the data needed to connect to a cluster.
Agent 1 then makes a connection petition to the cluster (arrow 4) and gets the list of voters who have already joined the cluster.
Agent 1 then verifies the identity of the members of the cluster by means of an Authentication Server (arrow 5).

FIG. 2, itemizes—in a block diagram—the process flow concerning a case of practical application in which the system of the invention is used to register the votes of 4 users, representing a simplification of the most general case in the use of the invention. It corresponds with phase 2 in the detailed description of the invention:
On the upper part, a table is shown which describes the virtual ballot that every agent selects in each round. Each row represents a round. The first column displays the round number. The next four columns display the choices taken by each agent in each round. The last column displays the remaining ballots at the end of each round.
At the bottom, a graph is displayed step-by-step describing which ballots are chosen by each agent in each round. Chosen ballots are displayed at the top of each circle, and each circle represents a choice from an agent. The input to each circle indicates the ballots that each agent receives, and the output indicates the remaining ballots after the agent selects the ballot indicated over the circle. Each agent repeats this action three times as described in the former table. The first input arrow displays all ballots initially generated, and the last one displays the remaining ballots at the end of the process. The value of the remaining ballots makes it possible to deduce the result of the vote, as described in the detailed description of this invention.

FIG. 3 displays a verification table for the voting shown in FIG. 2. For this example, a validation scheme 100 has been implemented, in which each agent asks the other Voting Agents for only one vote-option identifier.

Each box in the table displays the value that the agent from the column passes to the agent from the row. This figure summarizes the steps taken in phase 3 (verification) of the detailed description of this invention.

As an example, the box corresponding to Agent B at the column and Agent A at the row displays the identifier N3. This indicates that Agent A asked Agent B for an identifier corresponding to option N. Agent B could have returned the identifier N3 or the identifier N6, given that in the first round, it selected N3 and in the third, N6. Agent A, on receiving identifier N3, checks that such an identifier is neither one of the identifiers that he selected, nor one of the identifiers in the list of the remaining ballots.

Now, at the box corresponding to Agent C at the column and Agent A at the row, Agent A asks Agent C for 110 an identifier corresponding to option R, and Agent C returns the identifier R5 which it selected in the third round.

### DETAILED DESCRIPTION

### Notation:

Virtual ballot box: Figurative element representing a container with the votes of several legitimate voters in 115 a given election.

N: size of the cluster in a virtual ballot box

o: number of options that can be voted

k: multiplication factor

The cryptographic processes and protocols included in the present invention require the performance of complex mathematical calculation by the voters. The complexity of such calculations require that, on the voter's behalf, they are performed by a Voting Agent created by a set of programs or software.

### Previous Assumptions:

Each voter does with a unique identifier for the election in which he/she wants to participate and with the data for connection to a listing of servers provided by one of several trusted authorities.
Each voter does with a pair of asymmetric keys granted, or not, by a trusted authority (generally a governmental agency). For example, in Spain, it could be a CERES certificate [Spanish Certification issued by the National Mint and Stamp Factory] or his/her electronic identification card.
A census was established including the persons or entities legally entitled to participate in the election. Such census can be carried out by a trusted authority or by any other means agreed by the parties involved in the election.
Optionally, each voter can do with a private identifier, provided by a trusted authority, that identifies the voter univocally but that does only allow such trusted authority to know the actual 135 identity of the voter.

### Phase 1: Creating a Virtual Ballot Box.

Step 1 (FIG. 1a y 1b). The voter communicates his vote for a given open election to the Voting Agent. This step does not have to be the first one necessarily; it can be performed anytime before the Voting Agent picks up any virtual voting slip. It could even be implemented in such a way that the vote is selected later 140 on and this would not modify the basic operation of the process.

Step 2 (FIG. 1a y 1b). The Voting Agent contacts a Cluster Control Server or a P2P network and requests an application for participation in the election.

Step 3 (FIG. 1a y 1b). The Voting Agent receives the data for connection to a cluster. If none is available, he is told to create one and wait for connections.

Step 4 (FIG. 1a y 1b). The Voting Agent creates the cluster or connects the indicated cluster. The communication among the cluster nodes will take place in a safe manner through any protocol available in the state-of-the-art or any other designed specifically for such communication. The safe protocol for communication among nodes is not part of this invention.

Step 5 (FIG. 1a y 1b). The Connection Agent verifies that the members of the cluster are legally entitled to 150 participation in the election. This verification can be performed against the Voters Legitimacy Verification

Server of a verification authority or by any other means. The protocol for verification of the legitimacy to participate in the election is not part of this invention. In turn, the rest of the members of the cluster verify the legitimacy of the new Agent for participating in the election.

In case a P2P network is being used to store the voting results in a distributed way, it will also be possible to check if the user has already voted, whether to rely on a verifier authority, or to rely on the nodes actually connected to the P2P network, or to avoid this verification.

If the cluster reaches the agreed number of connected Agents (N) and all the agents agree on the legitimacy of the cluster, the process can proceed to the voting phase.

### Phase 2: Voting (FIG. 2)

Step 1. The cluster creates a minimum of N* (k+1) virtual slips for each voting option. Each one of the virtual slips has a unique identifier associated to the voting option that it represents. All the voting agents in the cluster have the initial listing of virtual slips and know the vote represented by each one of them. The protocol for performing this step is not part of this invention. Any protocol available in the state-of-the-art shall be used or anyone specifically designed for this purpose.

Step 2. An order is established among the voting agents (optionally, the order can be established after each run of Loop 1). The protocol for establishing the order among the voting agents is not part of this invention.

Proceed with o*k+1 times (Loop 1):

Following the established order and until a complete run of the listing of agents, each one of the agents (Loop 2):

Step 3. Receives, from the agent preceding him/her in the listing, a listing of virtual slips available for a choice.

Step 4. Picks up a virtual slip from the listing and transfers the listing of remaining slips to the agent following him in the listing (only to him/her). The last one in the listing transfers the listing of remaining virtual slips to the first one in the listing.

Rules to be followed by all the agents:
When the o*k+1 runs of the listing are completed, each one of the agents must have, at least, k slips corresponding to each one of the voting options available, plus an additional slip that influences his/her vote towards the option to which it is associated.
If any inconsistency is detected (e.g., that no slips for a given option are available), the virtual ballot box will be labeled as invalid. If an Agent declares that the virtual ballot box is invalid, the cluster is dissolved and each one of the agents must look for a virtual ballot box in which he/she can be included. The vote by a single agent can dissolve the cluster because the certificate is not valid if it is not signed by the N voters.

Step 5. The last agent to opt informs the rest of the listing of remaining slips.

Step 6. Each Agent performs the pertinent checking, such as verifying that none of the remaining slips correspond to any of the ones selected (this would mean that an agent has altered the data).

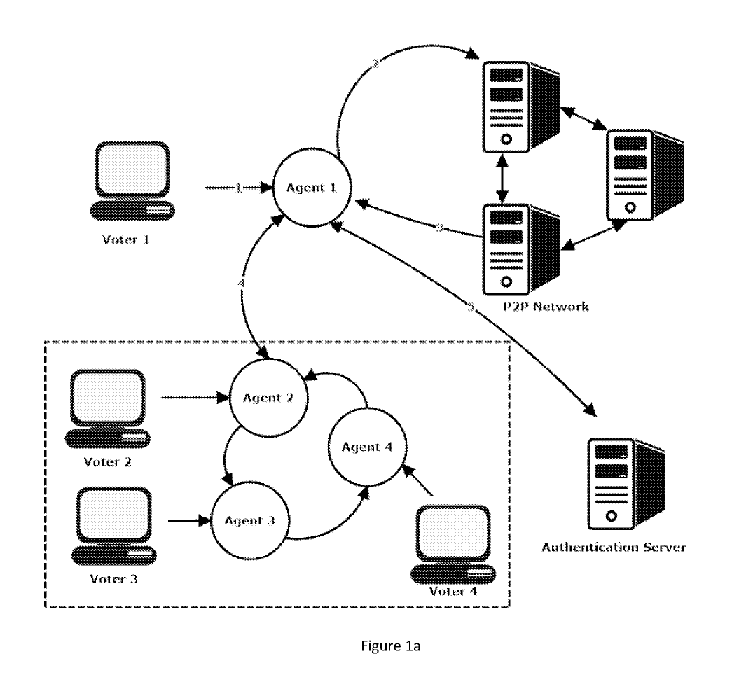

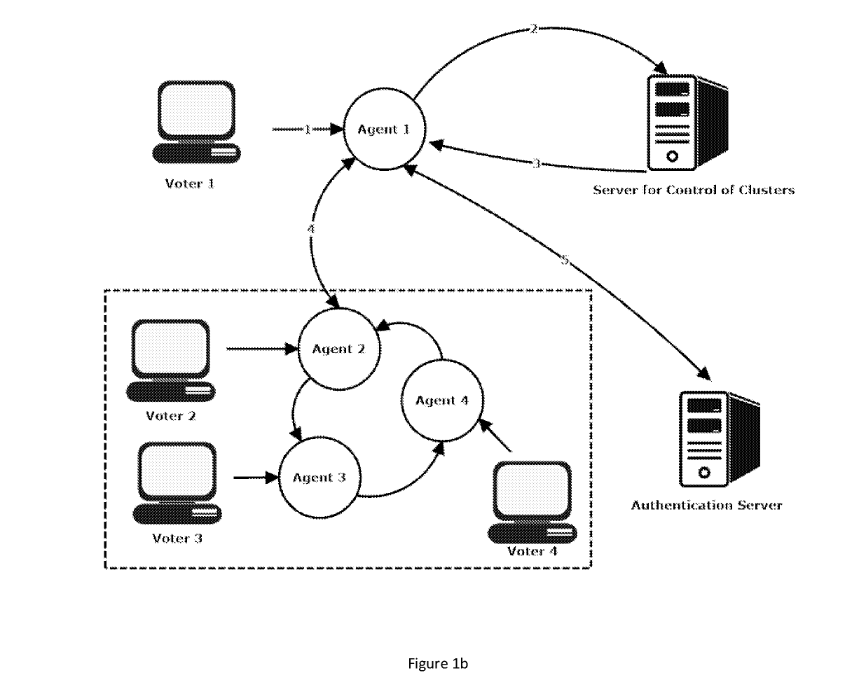

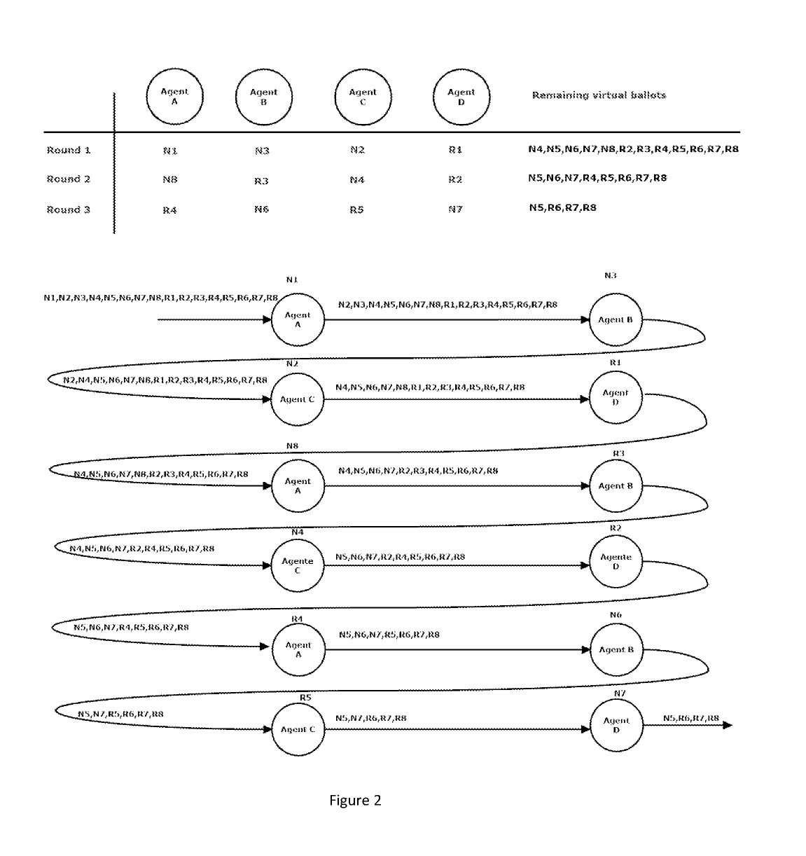

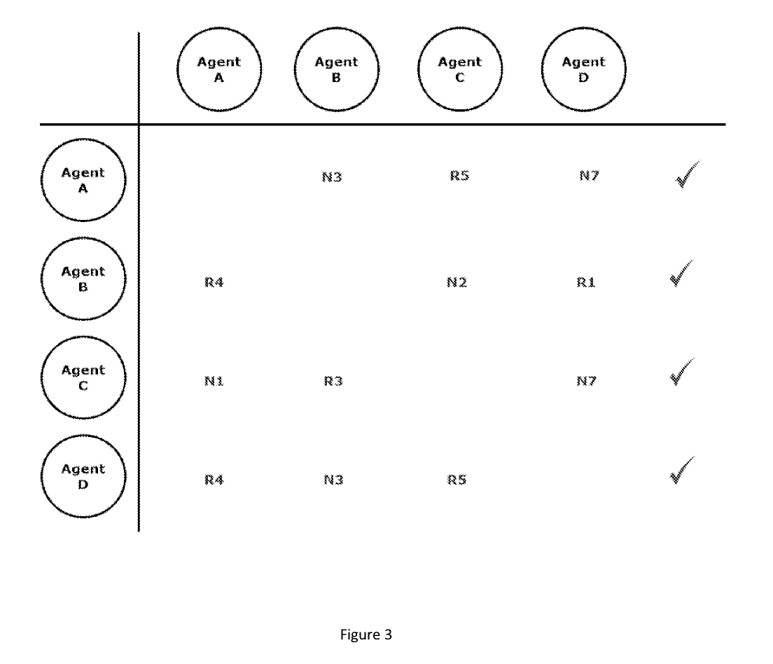

### Phase 3 Validation (FIG. 3)

Step 1. Each Agent asks a series of Agents for one (or more) vote identifier(s) associated to a given voting option. The latter responds privately to the querying Agent (no other node in the cluster gets to know the answer). The querying Agent verifies that there are no incoherent data. Any algorithm can be chosen for selecting which Agents pose a question, whom do they ask, how many voting options are asked to each queried Agent, how to select the voting option(s) for which a virtual slip must be introduced for each queried Agent, and how to determine if the data are incoherent. A possible serious performance would be having 20 Agents selected at random ask the rest of the nodes, randomly, about an option, and an incoherence is detected if someone repeats an option identifier or the option identifier is in the listing of remaining identifiers after the voting. If any incoherence is detected, the voting is labeled as invalid. The objective is that the probability of someone cheating and not being detected be very small and that, at the same time, the probability of a voting agent finding out which was the vote of another agent be nil or very small. No concrete protocol for performing this step is part of this invention, but only the general features mentioned in this paragraph that need to be contained by such protocol.

Step 2. If all the agents agree that no error has been made, a digital certificate is issued and signed with the private key of each one of the voters. The certificate shall include, at least, the result of the votes, which is deducted from the number of remaining slips, plus an identifier for each voter. The identifier associated to each voter can be public (anyone can get to know the identity of the voter) or only shared with a trusted authority coordinated with the trusted authority in charge of re-counting the votes (both can be the same).

### Phase 4: Certification

### Step 1 (Optional)

A certificate is sent to one or more Certification Servers, who sign the certificate using their private key and return it to each one of the Voting Agents so that they can replace the original certificate by the one signed by the authority. Optionally, such a Certification Server can verify that different parameters are accomplished for the election, such as not surpassing the enabled number of votes per user.

### Paso 2.

The certificate is delivered to a trusted authority in charge of re-counting or to the P2P network.

If it is delivered to a trusted authority (Count Server), this authority stores it until the election ends. Optionally, this Count Server can verify that different parameters are accomplished for the election, such as not surpassing the enabled number of votes per user. Optionally, each Agent can send the result to additional trusted authorities or any other independent entity supervising the election.

If it is delivered to a P2P network, the nodes on this network will send the certificate to all the nodes in the network according to the collaborative algorithm that they employ. Once the certificate is stored in the P2P network, anyone can get this information to verify the election process.

### Phase 5: Re-count Consultation of Results of the Election

Once the voting period is over:

If a trusted authority has been established for re-counting, such authority will add the results of all the virtual boxes. The addition corresponds with the general result of the election. Next, the authority shall issue a listing with the identifiers of each one of the virtual boxes and the results in each one of them, so that all users can verify that their votes were registered. Optionally, the authority can also publish the (public or private) identifiers of each one of the voters.

If a P2P network was used, the network contains the list of results for each one of the virtual boxes. Any user can insert his/her results and verify the overall result of the election, as well as verify that his/her vote is included. Optionally, there may be Publication Servers dedicated to perform the vote count, and voters can consult the results from these servers.

In one of the variables for implementation, the P2P network stores the results of the voting codified by means of a key generated by a central authority and, upon completion of the electoral process, such authority publicizes the key, allowing deciphering the data in the P2P network. Thus, the partial results of the election are not known until the latter is completed and, therefore, this prevents the partial results of the election from influencing some voters. The protocol for encrypting the votes of the P2P network is not a part of this invention. A possible implementation of such a protocol would imply the use of a pair of asymmetric keys. The public key would serve to codify the results in the virtual ballot boxes, and the private key would be publicized at the end of the election.

1- Secure electronic voting method, which uses at least one Cluster Control Server and a set of Voting Agents, each of them provided with computing means and preferably interconnected in case of 245 dispersion by at least one communication network, comprising cryptographic processes and protocols that run throughout the implementation of the method and completed once in an electoral process, ensures a number of security requirements specific to the electoral process, characterized by comprising the following stages: a) creating a Virtual Ballot Box made up of various Voting Agents, which mutually verify the legitimacy of each voter to vote; b) an exchange of messages between Voting Agents following these steps:
(i) Creating virtual ballots
(ii) Setting an order between Voting Agents
(iii) Making o*k+1 times: Following the established order, and until completing a lap to the agent list, each agent: (iv) gets from the previous agent in the list, a list of virtual ballots yet to be selected, (v) extracts a virtual ballot from the list and passes the list of remaining ballots to the next agent. Such a ballot election must respect the rule that at the end of the process (o*k+1 selections), each agent should have selected k ballots from each option and an additional ballot which identifies the option he/she voted for.
(vi) The last agent who selects a virtual ballot announces the final list of remaining ballots.
(vii) Each Voting Agent makes the necessary checks to verify data consistency.
c) Each Voting Agent asks a number of Voting Agents for one (or more) virtual ballot identifier associated with a particular voting option. They respond privately to the asking Voting Agent (no other node in the cluster knows the answer). The asking Voting Agent verifies that there are no inconsistencies in the answer.
d) Optionally, the Voting Agents sign the result.

2- The method of claim 1, wherein at the end of the verification phase, the Voting Agents communicate the result of the vote to one or more Count Servers. The Count Server will store the results from the virtual ballot boxes and it can (a) use them to calculate a final result and send the result to one or more Publishing Servers (the same Count Server can be a Publishing Server at the same time) or (b) send such results to other Count Servers.

3- The method of claim 1, wherein the Voting Agents, at the end of the verification phase, communicate the outcome of the vote to a P2P network. The P2P network will store the results from every virtual ballot box in a distributed data structure and it can (a) use them to calculate a final result and send the result to one or more Publishing Servers or (b) send such results to other Count Servers, or (c) make it possible for anyone to download the stored data and calculate a result.
